(19) United States
(12) Patent Application Publication
(10) Pub. No.: US 2007/0176380 A1
(43) Pub. Date: Aug. 2, 2007

(54) Convertible barrow for ground level loading

(76) Inventor: William C. Crutcher, Middlebury, CT (US)

Correspondence Address: WILLIAM C. CRUTCHER;DBA WHITEFIELD COMPANY, P.O. BOX 276, MIDDLEBURY, CT, 06762, US

(21) Appl. No.: 10/590,329

(22) PCT Filed: Feb. 16, 2005
(86) PCT No.: PCT/US05/04958

§ 371 Date: Aug. 23, 2006

(51) Int. Cl. B62B 1/00

(52) U.S. Cl. 280/47.23

(57) ABSTRACT

Improvements to a known convertible barrow for ground level loading with a pivotable wheel carriage (36) for either resting on the ground for loading or pivoted under the barrow platform (20) for transporting a load. The improvements locate the pivot points (48) of the wheel carriage equidistant from the wheel carriage when it is adjacent the inclined rear wall (18),when it passes the heel end (24) during pivoting and when it is adjacent the midpoint of the platform to obtain a minimum, tilt angle during conversion. A pivotable gate (36) provides a closure member (56) for retaining the load at the time of tilting the barrow and is pivotable about pivot points (55) on arms (58, 60) to an open position.

### CROSS REFERENCE TO RELATED APPLICATIONS

The present application claims priority of U.S. Patent application Ser. No. 60/547,515 filed Feb. 25, 2004.

### BACKGROUND OF THE INVENTION

This invention relates to improvements in a known type of convertible barrow for ground level loading and more particularly to an improved placement of the pivoting carriage in an optimum location along with an improved retaining gate which is easy to manipulate. A known type of convertible barrow for ground level loading is disclosed in reexamined U.S. Pat. No. 5,593,271 issued Jan. 14, 1997, and in U.S. Pat. No. 5,810,543 issued Sep. 22, 1998, both in the name of John R. Hall. In the foregoing Hall patents, a pivoting wheel carriage is mounted so as to pivot from a first position in which the wheels rest on the ground behind a flat platform to a second position in which the wheel carriage cross member is disposed at the midsection of the flat platform so as to support the load. The location of the pivot point body of the Hall convertible barrow is such that the barrow is tilted at a rather large angle in order for the wheels to pivot. Also in the Hall patent, a retaining gate is used to close the open end of the barrow, sliding between channel members mounted on opposing sidewalls. This sliding gate requires the user difficulty to manipulate it into the channels. A number of devices are shown in the prior art that are convertible between a snow scoop, which also has wheels so as to be convertible into a handcart. In the snow-scooping mode, handles are used to push up the shovel against the snow so that it enters the open end of the container. When converted into a garden cart, these devices include wheels that are moved into position to support the contents of the cart. U.S. Pat. No. 3,594,932 issued Jul. 27, 1971 to Eriksson discloses a container with to a pivotably mounted carriage in which the wheel axle contacts the rear wall of the container so that it can be transported by tilting the handles downwardly to lift it slightly off of the ground. Eriksson has no retaining gate nor do the wheels pivot to rest under the flat section of the body that rests on the ground.

U.S. Pat. No. 5,123,187 issued in Jun. 23, 1992 to Zamaria describes a combined snow scoop and multipurpose handcart with a pivoting gate operated by a tether attached to the handle. A pair of wheels are foldable on hinges attached to the sidewalls. When the scoop is resting flat on the ground, the wheels are suspended in the air. There is no cross member beneath the platform supporting the load, so that the load is carried in torsion by the hinges. U.S. Pat. No. 2,930,152 issued Mar. 29, 1960 to Pipkin describes a wheeled shovel with a pivoting wheel carnage mounted on a pivot bracket attached beneath the handle, so that the wheels can unfold from a retainer on the handle to a location beneath the container. A pivoting gate mounted on arms attached to the side of the container swings between a closed position in front of the container to an open position at the rear of the container. The wheel carriage along with the wheels is entirely below the container platform and the device is unsuitable for ground level loading.

It would be desirable have a convertible barrow which requires the minimum amount of tilting in order to swing the wheels to a location at the midpoint of the body so that the carriage cross member supports the body.

It would also be desirable to have a convertible barrow with improved means for transporting the barrow in an unloaded condition and to more effectively unload the barrow. It would also be desirable to have a convertible barrow with a retaining gate for the load that is easily closed and opened before the barrow is tilted for loading or unloading.

### SUMMARY OF THE INVENTION

Briefly stated, the invention comprises a convertible barrow comprising a body having a substantially flat platform arranged to rest flat on the ground, the platform having a toe end and a heel end and arranged to receive a load at the toe end from substantially ground level, opposed side walls, and a rear wall extending upwardly from the heel end of the flat platform, a handle attached to the body and extending upwardly and rearwardly from the body and arranged such that a user may tilt the body on either the toe end or the heel end of the platform, a wheel carriage having at least two spaced wheels rotatably mounted on a cross member, a pair of wheel pivot arms each pivotably connected to the cross member at one end thereof and pivotably connected to the opposed side walls at first pivot points at the other end thereof and spaced apart by a width greater than the width of the platform, and a gate for retaining the load when the platform is tilted, said convertible barrow being characterized in that:

said rear wall is inclined rearwardly from the heel end of the platform to define a rear support section and in that the barrow carriage is pivotable from a first position where the wheels and barrow platform are both resting on the ground and said cross member is adjacent said rear support section, through a second position in which said cross member closely passes the heel end of the platform to a third position in which said cross member is adjacent the midpoint of said platform, said first pivot points on the body being located substantially equidistant from the carriage cross member in each of the first, second and third positions, and said convertible barrow being further characterized in that the gate comprises a closure member arranged to extend between the opposed side walls at the toe end of the platform and a pair of pivot arms each being connected to the closure member at one end thereof and pivotably disposed at second pivot points in the opposed side walls at their other ends, said gate being pivotable from an open position toward the rear wall to a closed position on the toe end of the platform with the closure member extending between the opposed side walls to retain the load.

### DRAWING

The invention will be better understood by reference to the following description, taken in connection with the accompanying drawing, in which:

FIG. 1 is a top plan view of my convertible barrow,

FIG. 2 is a side elevation view thereof,

FIG. 3 is an end elevation view thereof,

FIG. 4 is a partial cross sectional side elevation view,

FIG. 5 is a simplified schematic side elevation view of the barrow in an unloaded transporting position,

FIG. 6 is a similar view of the barrow in a loading position with the retaining gate open,

FIG. 7 is a similar view of the barrow with the gate in a closed position,

FIG. 8 is a similar view of the barrow swinging the wheel carriage to a loaded transporting position,

FIG. 9 is a similar view of the barrow transporting a load, and

FIG. 10 is a similar view of the barrow dumping the load with the gate in the open position.

### DETAILED DESCRIPTION OF THE PREFERRED EMBODIMENT

Referring now to FIGS. 1, 2 and 3 of the drawing, a convertible barrow is shown generally at 10. The convertible barrow 10 comprises a body 12 with opposed sidewalls 14, 16, and an inclined rear wall 18, extending upwardly from a flat platform 20. The platform 20 extends between a “toe” end 22 and a “heel” end 24.

Attached to body 12 is a handle 26 comprising two spaced longitudinal members 28, 30 extending upwardly and rearwardly from body 12 and joined by a cross member 32. The lower ends of the longitudinal members 28, 30 are inserted into sockets molded into sidewalls 14, 16 of the body, one such socket being shown at 34. The lower ends are also bolted to the sidewalls by bolts 29, 31.

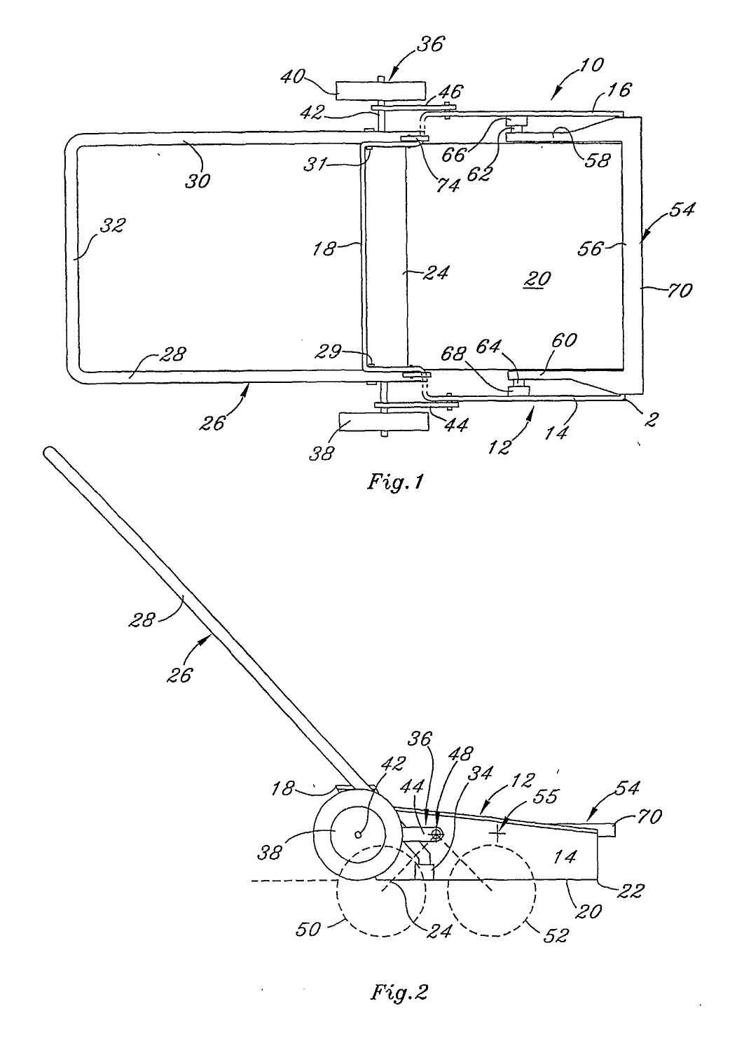

A pivotable wheel carriage, shown generally at 36, comprises a pair of wheels 38, 40 rotatably mounted on an axle 42. Axle 42 comprises a carriage cross member, and could also be a channel, I-beam, or similar load supporting member upon which wheels 36, 38 are rotatably mounted. The wheel carriage 36 includes a pair of pivot arms indicated in FIG. 1 by reference numbers 44, 46. One end of each of the pivot arms 44, 46 is pivotably mounted on axle 42. The other end of each of the pivot arms 44, 46 is pivotably mounted on a respective one of opposed sidewalls 14, 16 of the body. One such pivot point is seen at reference number 48 in FIG. 2, designated as a “first pivot point”. A corresponding “first pivot point” is located on the opposed sidewall.

The wheel carriage 36 is pivotable as best seen in FIG. 2 from a first position in which the wheels rest on the ground through a second position in which the axle 42 just clears the heel end 24 of the platform 20 to a third position in which the axle 42 rests beneath the midpoint of the platform 20. These three positions are indicated in FIG. 2. The first position with axle 42 adjacent a rear support section of the inclined back wall 18 is shown in full lines. The second position with the age just passing heel 24 is shown in dashed lines by reference number 50. The third position with the axle beneath the midpoint of the platform 20 is shown in dashed lines at reference number 52.

In accordance with one aspect of the present invention, the preferred construction employs a rear wall 18 that is inclined so as to form an included angle with platform 20 about the heel 24 on the order of 120°. See FIG. 4 for this preferred inclination where the axle 42 is positioned closely adjacent the rear wall. The preferred location for first pivot point 48 is along a vertical line drawn from a point on the platform that is one quarter of the distance from the heel to the toe of the platform. The height of pivot point 48 along this vertical line is then determined by the chosen diameter of wheels 36, 38.

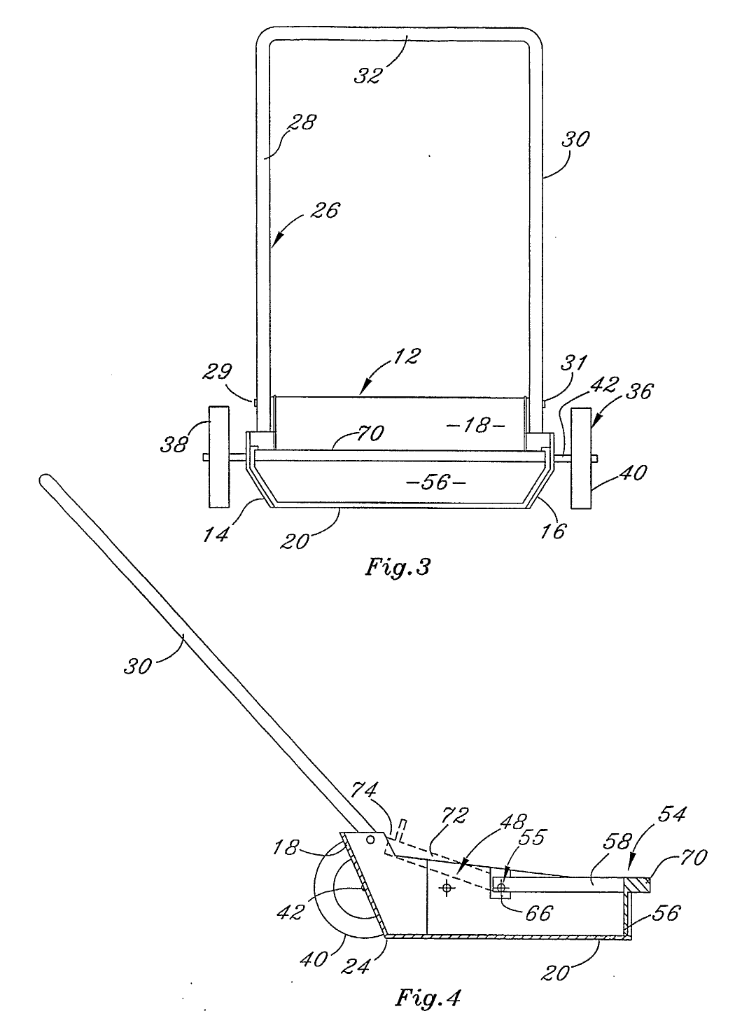

The sidewalls 14, 16 of the body may be flared out from the platform toward the front part of the body as indicated in the end elevation view of FIG. 3. Wheels 36, 38 are spaced apart from one another by a width at least as great as the width of a central support section located midway between the heel end and toe end of the platform. The wheel spacing may be increased slightly to avoid interference with the sidewalls 14, 16 if they are flared outwardly. In accordance with another aspect of the present invention, as best seen in FIG. 4, a pivotable gate, shown generally at 54, is mounted to pivot around “second pivot points” 55 in the opposed sidewalls 14, 16. As seen in the drawing, the second pivot points 55 are located at a separate location spaced from the first pivot points on the opposed sidewalls. However, the second pivot points may be located on a common support together with the first pivot points in order to simplify the mounting of both the pivotable gate 54 and the wheel carriage 36. Gate 54 includes a closure member 56 that blocks the open end of body 12, and a pair of pivot arms 58, 60. The pivot arms include pivot pins 62, 64 that are contained in pivot holes formed in bosses 64, 68 on the respective sidewalls. Pivot arms 58, 60 are flexible enough in a lateral direction to allow the pivot pins 62, 64 to be disengaged front the sidewalls in order to remove the pivotable gate 54. Closure member 56 preferably includes a lip 70 that extends beyond the end of body 12.

Referring to the cross section of FIG. 4, more details can be seen of the pivotable gate 54. Gate 54 pivots from a closed position shown in the drawing to an open position indicated by the dashed lines 72. Pivotable gate 54 may be locked in the open position 72 by a suitable latching mechanism 74. This latching mechanism 74 may be a suitable spring biased hook that will catch on the lip 70 to hold the pivoting gate open or may be a spring clip attached to the gate pivot arms that engages the handle 26.

### INDUSTRIAL APPLICABILITY

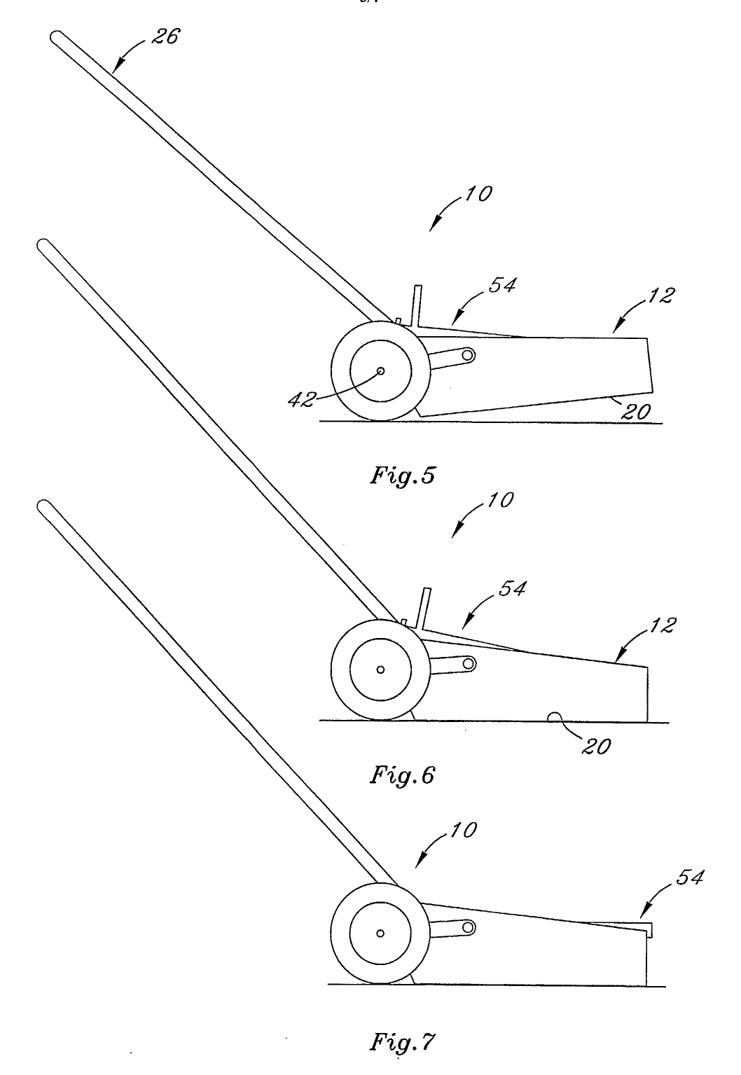

Operation of the invention will be understood by reference to the simplified schematic views of FIGS. 5-10. FIG. 5 shows the unloaded transporting position. The pivotable gate 54 is in the open position. By depressing the handle 26, platform 20 is tilted back on the heel and the rear support section of the inclined back wall 18 of barrow 12 is then supported by the axle 42. Platform 20 clears the ground and the barrow 12 may be easily transported to the loading site. FIG. 6 illustrates the loading position with the platform 20 flat on the ground and pivotable gate 54 open. A load of material to be transported can be raked or shoveled into the open end of body 12. Alternately, a heavy object may be shoved into the open end of body 12 from ground level. In the latter case, the pivotable gate 54 might or might not be necessary and may remain in the open position for a load such as a potted plant or refuse container.

FIG. 7 illustrates the barrow in the same position as FIG. 6, but with the pivotable gate 54 pivoted into a closed position preparatory to tipping the barrow on the toe end of the platform to enable swinging the wheel carriage. The second pivot points for the pivotable gate are located so as to enable the gate to pass above a load that is swept or raked onto the platform when the gate is pivoted from the open position to the closed position.

FIG. 8 illustrates the swinging of the wheel carriage 36 into the loaded transporting position. In order to accomplish this, the handle 26 is raised by the operator to tilt the platform 20 on the toe end, raising the heel end so that the wheel carriage 36 may swing freely on pivot arms 44, 46. The location of the first pivot points 48, as previously described, requires a minimum tilting of platform 20 during loading. The closure member 56 of the pivotable gate 54 keeps the load from coming out of the open end of body 12 when the platform is tilted.

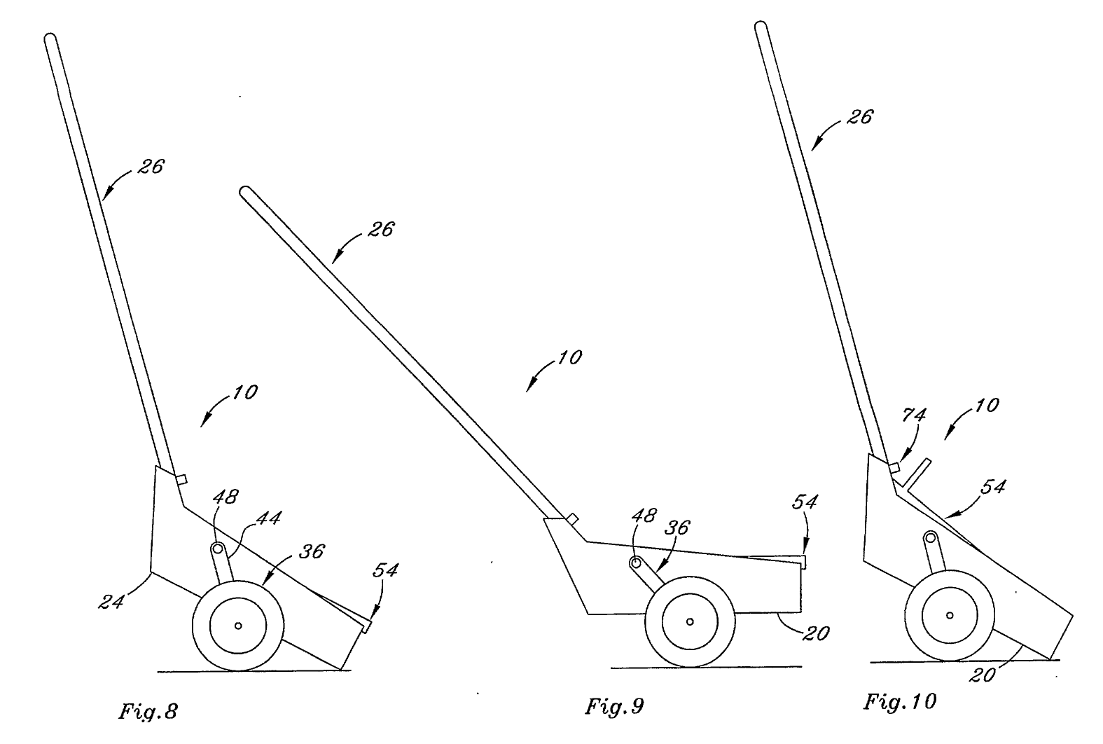

The carriage 36 swings from the first position shown in FIGS. 6 and 7 past the heel end 24 of the platform. Swinging of the wheel carriage, aided by rolling of the wheels, continues until the axle or other cross member of the carriage 36 reaches the midpoint of platform 20 as shown in FIG. 9. The load is then transported to a dumping site by pushing or pulling handle 26, with the load balanced and primarily supported by the cross member in a previously known fashion as set forth in the aforementioned Hall U.S. Pat. Nos. 5,810,543 and 5,593,271.

Upon reaching the dumping site, pivotable gate 54 is pivoted to the open position. If desired, latch 74 may retain it in the open position, but this is not absolutely necessary. The load is dumped by the operator elevating the handle 26 so that the body tips forward on the toe end of platform 20. Thus, the load is discharged from the open end of the body.

While there has been described what is considered to be the preferred embodiment of the invention, other modifications will occur to those skilled in the art, and it is desired to secure in the appended claims all such modifications as fall within the true spirit and scope of the invention.

1. A convertible barrow comprising a body having a substantially flat platform arranged to rest flat on the ground, the platform having a toe end and a heel end and arranged to receive a load at the toe end from substantially ground level, opposed side walls, and a rear wall extending upwardly from the heel end of the flat platform, a handle attached to the body and extending upwardly and rearwardly from the body and arranged such that a user may tilt the body on either the toe end or the heel end of the platform, a wheel carriage having at least two spaced wheels rotatably mounted on a cross member, a pair of wheel pivot arms each pivotably connected to the cross member at one end thereof and pivotably connected to the opposed side walls at first pivot points at the other end thereof and spaced apart by a width greater than the width of the platform, and a gate for retaining the load when the platform is tilted, said convertible barrow being characterized in that:
said rear wall is inclined rearwardly from the heel end of the platform to define a rear support section and in that the barrow carriage is pivotable about said first pivot points from a first position where the wheels and barrow platform are both resting on the ground and said cross member is closely adjacent said rear support section and disposed to support said inclined rear wall when the handle is depressed so as to elevate the platform above the ground, through a second position in which said cross member closely passes the heel end of the platform to a third position in which said cross member supports the middle of said platform, said first pivot points on the body being located substantially equidistant from the carriage cross member in each of the first, second and third positions.

2. The convertible barrow according to claim 1, said rear wall being inclined so as to form an included angle with said platform about said heel end on the order of 120°.

3. The convertible barrow according to claim 1, wherein said first pivot points are located along a vertical line drawn from a point on the platform that is one quarter of the distance from the heel end to the toe end of the platform.

4. The convertible barrow according to claim 1, said gate comprising a closure member arranged to extend between the opposed side walls at the toe end of the platform and a pair of pivot arms each being connected to the closure member at one end thereof and pivotably disposed at second pivot points in the opposed side walls at their other ends, said gate being pivotable about said second pivot points from an open position above the rear wall to a closed position on the toe end of the platform.

5. The combination according to claim 4, wherein said opposed sidewalls define bosses with holes coaxial with the second pivot points and wherein said closure member pivot arms terminate in pins disposed in said holes.

6. The combination according to claim 5, wherein said closure member pivot arms are flexible in a lateral direction to permit said pins to be withdrawn from said holes so as to allow the closure member to be detached from the barrow.

7. The combination according to claim 4, including a latching mechanism to hold said gate temporarily in an open position.

8. A convertible barrow comprising a body having a substantially flat platform arranged to rest flat on the ground, the platform having a toe end and a heel end and arranged to receive a load at the toe end from substantially ground level, opposed side walls, and a rear wall extending upwardly from the heel end of the flat platform, a handle attached to the body and extending upwardly and rearwardly from the body and arranged such that a user may tilt the body on either the toe end or the heel end of the platform, a wheel carriage having at least two spaced wheels rotatably mounted on a cross member, a pair of wheel pivot arms each pivotably connected to the cross member at one end thereof and pivotably connected to the opposed side walls at first pivot points at the other end thereof and spaced apart by a width greater than the width of the platform, and a gate for retaining the load when the platform is tilted, said convertible barrow being characterized in that:
said rear wall is inclined rearwardly from the heel end of the platform to define a rear support section and in that the barrow carriage is pivotable about said first pivot points from a first position where the wheels and barrow platform are both resting on the ground and said cross member is closely adjacent said rear support section and disposed to support said inclined rear wall when the handle is depressed so as to elevate the platform above the ground, through a second position in which said cross member closely passes the heel end of the platform to a third position in which said cross member supports the middle of said platform, said first pivot points on the body being located substantially equidistant from the carriage cross member in each of the first, second and third positions, said gate comprising a closure member arranged to extend between the opposed side walls at the toe end of the platform and a pair of pivot arms each being connected to the closure member at one end thereof and pivotably disposed at second pivot points in the opposed side walls at their other ends, said gate being pivotable about said second pivot points from an open position above the rear wall to a closed position on the toe end of the platform.
